(19) United States
(12) Patent Application Publication
(10) Pub. No.: US 2025/0354428 A1
(43) Pub. Date: Nov. 20, 2025

(54) CHARGING CONNECTION DEVICE FOR AN ELECTRICALLY POWERED VEHICLE

(71) Applicant: MERCEDES-BENZ GROUP AG, Stuttgart (DE)

(72) Inventors: Mark RENNER, Esslingen (DE); Karina KOHLER, Boeblingen (DE); Juergen BENECKE, Ludwigsburg (DE); Holger STEIN, Arnsberg (DE)

(21) Appl. No.: 18/717,479

(22) PCT Filed: Dec. 2, 2022
(86) PCT No.: PCT/EP2022/084317

§ 371 Date: Jun. 7, 2024

(30) Foreign Application Priority Data
Dec. 9, 2021 (DE) 10 2021 006 063.6

(51) Int. Cl. E05F 15/70; B60L 53/16

(52) U.S. Cl. CPC E05F 15/70; B60L 53/16; E05Y 2900/534

(57) ABSTRACT

A charging connection device includes a combined DC-AC charging connection with AC contact elements and DC contact elements. A cover arrangement has a covering position and at least two releasing positions. The releasing positions are each assigned to a charging mode. The cover arrangement includes at least one movably mounted cover element, which is movable between a covering position and at least one releasing position. In a first releasing position of the cover arrangement, the AC contact elements of the DC-AC charging connection are released and the DC contact elements of the DC-AC charging connection are covered by at least one of the cover elements. In the second releasing position of the cover arrangement, the AC contact elements and the DC contact elements of the DC-AC charging connection are released. In the covering position of the cover arrangement, the charging connections are covered by at least one cover element.

### BACKGROUND AND SUMMARY OF THE INVENTION

Exemplary embodiments of the invention relate to a charging connection device for an electrically powered vehicle with two charging connections.

DE102021000307A1 discloses a charging connection device for an electrically powered vehicle with two charging connections arranged next to each other with a first DC charging connection and a second DC and/or AC charging connection. In addition, the charging connection device comprises at least one charging connection cover that covers at least one of the two charging connections. The charging connection cover is designed in such a way that only one of the two charging connections is accessible for contacting, while the other of the two charging connections is covered by the charging connection cover.

According to the prior art, electric cars require a separate charging connection for each charging standard and therefore two charging connections are provided on the vehicle for two charging options of different standards.

One charging standard currently used in Europe, for example, is the Combined Charging System (CCS). This allows charging with direct current and alternating current. Another standard, CHAdeMO=“Charge de Move”, was developed in Japan and offers a charging capacity of up to 50 kW.

For alternative or future charging standards with outputs of several hundred kilowatts or even more with outputs of at least one megawatt and more, a further charging connection, in particular a DC voltage connection, is provided in accordance with a further, alternative plug standard. Several charging connections can be electrically connected in one path so that the charging sockets are energized at the same time.

Exemplary embodiment of the invention are directed to an improved charging connection device for an electrically powered vehicle with two charging connections.

Expedient embodiments and advantages of the invention can be found in the description and the drawing.

According to one aspect of the invention, a charging connection device for an electrically powered vehicle is proposed with at least one charging connection designed as a combined DC-AC charging connection with AC contact elements and DC contact elements. In addition, the charging connection device comprises a cover arrangement having a covering position and at least two releasing positions, wherein the releasing positions of the cover arrangement are each assigned to a charging mode. The cover arrangement comprises at least one movably mounted cover element, which can be moved between a covering position and at least one releasing position. In a first releasing position of the cover arrangement, the AC contact elements of the DC-AC charging connection are released and the DC contact elements of the DC-AC charging connection are covered by at least one of the cover elements. In the second releasing position of the cover arrangement, the AC contact elements and the DC contact elements of the DC-AC charging connection are released. In the covering position of the cover arrangement, the charging connections are covered by at least one cover element.

In the following, a charging connection is understood to be a device, for example a charging socket, which is electrically coupled to an energy storage device and which can be electrically connected to a corresponding plug which is electrically coupled to a voltage source. When connected, the energy storage device of the electrically powered vehicle is charged by the voltage source. The charging connection has contact elements arranged in the form of a mating face, wherein the plug has a mating face with contact elements arranged congruently with contact elements of the charging connection. The two charging connections differ in the arrangement and/or design of the contact elements.

The combined DC-AC charging connection can be designed, in particular, as a CCS charging connection with two types of contact elements. Here, the AC contact elements can form a first mating face, which can be coupled with a mating face of a plug with congruent contact elements in order to charge the vehicle or its energy storage system with AC current in AC charging mode. The DC contact elements form a second mating face. A plug, which is coupled to the combined DC-AC charging connection in order to charge the vehicle or its energy storage device with direct current in DC charging mode, has two mating faces, which can be coupled to the two mating faces of the combined DC-AC charging connection.

Instead of the at least one combined DC-AC charging connection, a combined charging connection for two different plug standards can also be arranged in the charging connection device, both of which are intended for direct current or alternating current. The DC contact elements would then be contact elements for a first plug standard and the AC contact elements would then be contact elements for a second plug standard. The DC charging mode would then correspond to charging according to a first charging standard and the AC charging mode would correspond to charging according to a second charging standard, in each case for direct current or alternating current.

The respective charging connections or the contact elements not required for the current charging mode are mechanically covered by the at least one cover element. An opening and closing mechanism can, for example, move the at least one cover element into the covering position after the end of a charging process. In addition, the opening and closing mechanism can move the cover elements into the positions assigned to the charging mode when a charging mode is recognized. During the charging process, only the contact elements that are required in this charging mode are released. The other contact elements are covered so that they are safe to touch and protected from environmental influences.

Due to the cover arrangement with the at least one movably mounted cover element, the charging connection device can have three states in principle, wherein in a first state both plug faces of the combined DC-AC charging connection are covered. In a second state of the charging connection device, the DC contact elements are covered by the at least one cover element. As a result, in the second state, only the AC contact elements of the combined DC-AC charging connection are released for the AC charging mode. In a third state of the charging connection device, the DC contact elements and the AC contact elements of the combined DC-AC charging connection are released for a DC charging mode.

Due to these states of the charging connection device, it is only possible to couple a charging plug of a charging cable with the corresponding contact elements of the charging connection if the other charging connection or the contact elements that are not required are covered by the cover element so that they are safe to touch. This is an advantageous way of ensuring that the unused, energized contact elements are covered so that they are safe to touch while the energy storage device is charging. In addition, the unused, energized contact elements can be protected from environmental influences such as dirt or water in an advantageous manner. Furthermore, the at least one cover element reliably covers the at least one charging connection while the vehicle is being driven or parked when it is not being charged and protects the at least one charging connection from environmental influences and possible contact.

According to an advantageous embodiment of the charging connection device, a further charging connection can be electrically coupled to the combined DC-AC charging connection, in particular via a common electrical path, wherein at least one cover element of the cover arrangement covers the further charging connection when the cover arrangement has the first releasing position or the second releasing position or the covering position. By covering the contact elements of the further charging connection, these can be reliably covered during a charging process in AC charging mode or in DC charging mode or in driving mode or when parked, thereby protecting them from contact and environmental influences. By sharing the electrical path of the two charging connections, it is sufficient to use only one contactor in the electrical architecture of the vehicle's high-voltage electrical system to connect the electrical energy storage system. This saves costs, installation space, and weight compared to a connection with two contactors. If the two charging connections are arranged in a shared electrical path, both charging connections are energized at the same time.

According to an advantageous embodiment of the charging connection device, the further charging connection can be released in a third releasing position of the cover arrangement and the DC-AC charging connection can be covered by at least one cover element. The cover arrangement can thus have a third releasing position. In the third releasing position of the cover arrangement, the combined DC-AC charging connection or its contact elements are covered by at least one cover element and the further charging connection or its contact elements are released. As a result, contact elements of the combined DC-AC charging connection are covered so that they are safe to touch in the charging mode assigned to the other charging connection. The at least one cover element, which covers the other charging connection in the first releasing position and in the second releasing position of the cover arrangement, and the at least one cover element, which covers the combined DC-AC charging connection in a third releasing position, make it advantageously possible to dispense with a voltage-free switching of one of the charging connections. This means that a corresponding switching device, a so-called switch box, can be dispensed with, which saves additional costs and additional installation space.

According to an advantageous embodiment of the charging connection device, at least one sensor arrangement coupled to the cover arrangement can detect the charging mode according to alternating current or direct current. If an AC charging mode is detected, the cover arrangement can be moved to the first releasing position by a drive, for example a servomotor, or can be released to be moved to the first releasing position. If a DC charging mode is recognized, the cover arrangement can be moved to the second releasing position by the servomotor or released for movement to the second releasing position. If a charging mode assigned to the other charging connection is recognized, the cover arrangement can be transferred to the third releasing position by the actuator or released for transfer.

According to an advantageous embodiment of the charging connection device, the cover arrangement can comprise a cover element, which is designed as a charging connection cover and which is assigned to the combined DC-AC charging connection, wherein the charging connection cover releases the AC contact elements and covers the DC contact elements in a first releasing position. In a releasing second position of the charging connection cover, the charging connection cover can release the AC contact elements and the DC contact elements. In a covering position, the charging connection cover can cover the AC contact elements and the DC contact elements. The positions can be realized cost-effectively using a single cover element and a simple mechanism that moves the cover element into the various positions. For example, the contact elements can be arranged one below the other and the charging connection covers can be moved downwards from the covering position into the releasing positions, wherein the upper contact elements can be released first.

According to an advantageous embodiment of the charging connection device, the cover element associated with the combined DC-AC charging connection can have at least one sealing element. The sealing element can be arranged on a side facing the combined DC-AC charging connection. In particular, the sealing element can enclose an area that is arranged above the DC contact elements in the covering position. In addition, a further sealing element can enclose the area that is arranged above the AC contact elements in the covering position. Furthermore, a sealing element is conceivable which encloses an area which is arranged above the DC contact elements in the first releasing position. The sealing element can be used to seal the contact elements in predetermined positions of the cover element.

According to an alternative advantageous embodiment of the charging connection device, the cover arrangement can comprise a cover element designed as a charging connection cover and a cover element designed as a connection cover element. In a releasing position, the charging connection cover can at least partially release the combined DC-AC charging connection and in a covering position it can cover the combined DC-AC charging connection. The connection cover element can release the DC contact elements in a releasing position and cover the DC contact elements in a covering position. In the first position of the cover arrangement, in which the charging connection cover releases the combined DC-AC charging connection, only the alternating current contact elements are released by the additional connection cover element in the covering position. The DC contact elements are covered by the additional connection cover. In the second position of the cover arrangement, the charging connection cover also has the releasing position. The additional connection cover element also has the releasing position. This releases the AC contact elements and the DC contact elements. In the covering position or in the third releasing position of the cover arrangement, the connection cover element covers the DC contact elements and the charging connection cover covers the AC contact elements and the connection cover element.

According to an advantageous embodiment of the charging connection device, the charging connection cover can cover the additional charging connection in the releasing position. This can ensure that the contact elements of the additional charging connection are covered when the contact elements of the combined DC-AC charging connection are released. Furthermore, in the covering position, the charging connection cover releases the contact elements of the additional charging connection and covers the contact elements of the combined DC-AC charging connection. The two charging connections can be arranged next to each other. This allows the charging connection cover to be moved sideways to cover one of the two charging connections and release the other.

According to an advantageous embodiment of the charging connection device, an additional connection cover element can release the AC contact elements in a releasing position and cover the AC contact elements in a covering position. In this case, the charging connection cover can cover the connection cover element in a covering position.

According to an advantageous embodiment of the charging connection device, the at least one cover element can be designed as a rotationally movable and/or translationally movable flap and/or as a foldable or rollable or bendable roller blind and/or as a rotatable element, in particular as a perforated disc. In the case of a flap mounted to move in translation, it can be moved upwards or downwards or to the left and right. In this case, the respective flap can be moved outwards in front of an outer shell or inwards under the outer shell in order to be transferred to one of the releasing positions. In an alternative embodiment, a swiveling movement away from the charging connection can be implemented with a rotationally movable mounting. With a rotationally movable mounting, rotation in a plane that runs parallel to the contact elements is also possible. In this case, a recess in a perforated disc can be arranged in a releasing position of the perforated disc above the contact elements in order to release them for contacting. If the cover elements are designed as a roller blind, the cover elements can be rolled up or moved inwards or folded away inwards in an S-shape. The roller blind can be designed as an arrangement of slats or as a bendable spring plate. The rolling or folding movement can be executed upwards, downwards, to the left or to the right. The cover elements of the cover arrangement can be designed differently and can be moved differently.

According to an advantageous embodiment of the charging connection device, the two charging connections can be arranged in a common charging recess. When arranged in a common charging recess, the charging connections can be arranged on the vehicle to save space.

According to an advantageous embodiment of the charging connection device, at least one drive can drive the at least one cover element. The movement of the at least one cover element can be fully automatic or semi-automatic via an electric servomotor or several servomotors.

According to an advantageous embodiment of the charging connection device, at least one sensor arrangement coupled to at least the cover arrangement can determine a current charging mode. By determining the current charging mode, the required contact elements assigned to the current charging mode can be determined. Depending on the charging mode recognized by the sensor arrangement, the at least one drive can move the cover elements of the cover arrangement into the position in which only the charging connection assigned to the charging mode or the contact elements of the charging connection assigned to the charging mode are released. This enables fully automatic or semi-automatic release of the required contact elements. The at least one sensor arrangement can comprise a limit switch and/or an optical sensor and/or a camera. In addition, the sensor arrangement can be connected to a charging station via a communication system in order to receive information about the selected charging mode.

With the charging connection device according to the invention, it can be advantageously ensured that only one charging connection or certain contact elements are accessible for contacting and the other charging connection or the other contact elements are covered so that they cannot be touched.

Further advantages can be found in the following description of the drawings. The drawings show exemplary embodiments of the invention. The drawings, the description and the claims contain numerous features in combination. A person skilled in the art will also expediently consider the features individually and summarize them to form useful further combinations.

### BRIEF DESCRIPTION OF THE DRAWING FIGURES

In the drawings:

FIG. 1 shows a charging connection device for an electrically powered vehicle according to a first exemplary embodiment with a fully covered combined DC-AC charging connection;

FIG. 2 shows the charging connection device according to FIG. 1 with released AC contact elements of the combined DC-AC charging connection;

FIG. 3 shows the charging connection device according to FIGS. 1 and 2 with released AC contact elements and DC contact elements of the combined DC-AC charging connection;

FIG. 4 shows a charging connection device for an electrically powered vehicle according to a second exemplary embodiment with a fully covered combined DC-AC charging connection;

FIG. 5 shows the charging connection device according to FIG. 4 with released AC contact elements of the combined DC-AC charging connection;

FIG. 6 shows the charging connection device shown in FIGS. 4 and 5 with released AC contact elements and DC contact elements of the combined DC-AC charging connection;

FIG. 7 shows a charging connection device for an electrically powered vehicle according to a third exemplary embodiment with a fully covered combined DC-AC charging connection;

FIG. 8 shows the charging connection device shown in FIG. 7 with released AC contact elements of the combined DC-AC charging connection;

FIG. 9 shows the charging connection device shown in FIGS. 7 and 8 with released AC contact elements and DC contact elements of the combined DC-AC charging connection;

FIG. 10 shows a charging connection device for an electrically powered vehicle according to a fourth exemplary embodiment with a fully covered combined DC-AC charging connection;

FIG. 11 shows the charging connection device shown in FIG. 10 with released AC contact elements of the combined DC-AC charging connection;

FIG. 12 shows the charging connection device according to FIGS. 10 and 11 with released AC contact elements and DC contact elements of the combined DC-AC charging connection;

FIG. 13 shows a charging connection device for an electrically powered vehicle according to a fifth exemplary embodiment with fully covered contact elements;

FIG. 14 shows a cover arrangement of the charging connection device according to FIG. 13 in a covering position;

FIG. 15 shows a cover arrangement according to FIGS. 13 and 14 in a first releasing position;

FIG. 16 shows a cover arrangement according to FIGS. 13, 14 and 15 in a second releasing position;

FIG. 17 shows a cover arrangement with a cover element in a position that releases contact elements;

FIG. 18 shows a cover arrangement according to FIG. 17 with a cover element in a position covering the contact elements;

FIG. 19 shows a charging connection device for an electrically powered vehicle according to a fifth exemplary embodiment in a second releasing position;

FIG. 20 shows a charging connection device according to FIG. 19 in an intermediate position; and

FIG. 21 shows a charging connection device according to FIGS. 19 and 20 in a third releasing position.

In the figures, like or similar components are denoted by like reference signs. The figures only show examples and are not intended to be limiting.

### DETAILED DESCRIPTION

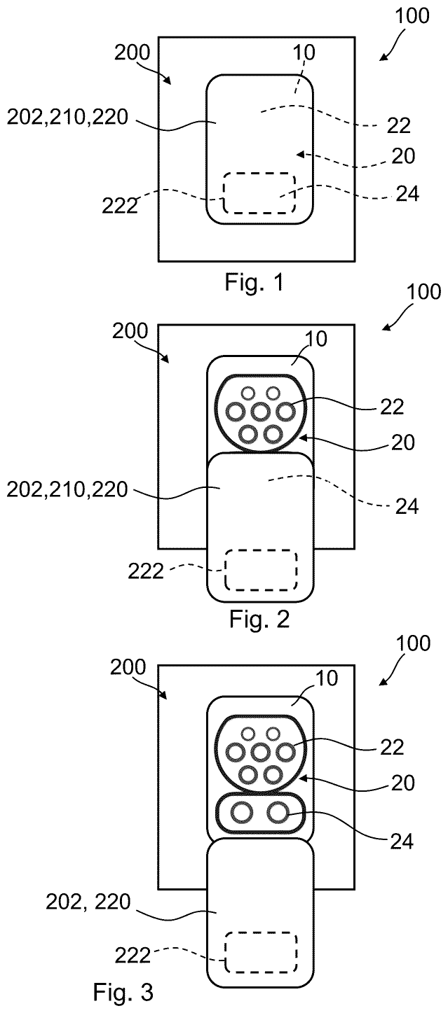

FIGS. 1 to 3 show a charging connection device 100 for an electrically powered vehicle according to a first exemplary embodiment with a combined DC-AC charging connection 20 and a cover arrangement 200 in a covering position (FIG. 1), a first releasing position (FIG. 2) and in a second releasing position (FIG. 3).

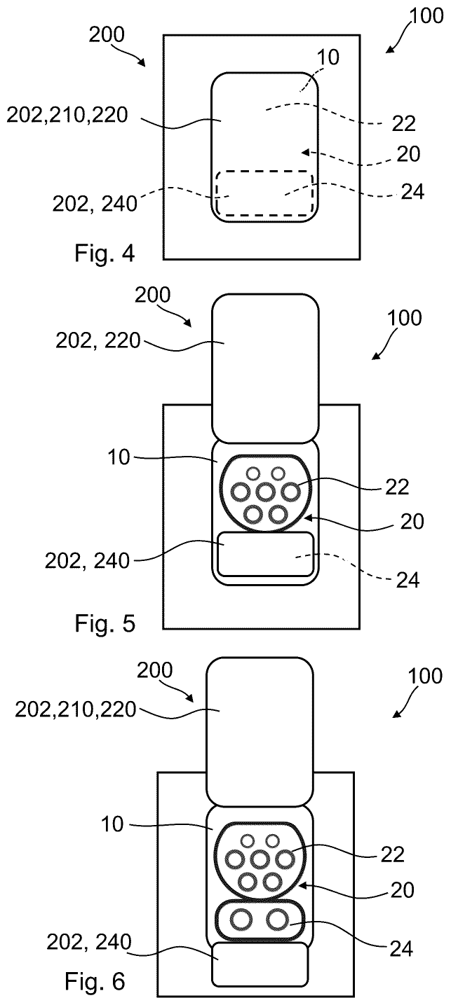

FIGS. 4 to 6 show a charging connection device 100 for an electrically powered vehicle according to a second exemplary embodiment with a combined DC-AC charging connection 20 and a cover arrangement 200 in a covering position (FIG. 4), a first releasing position (FIG. 5) and in a second releasing position (FIG. 6).

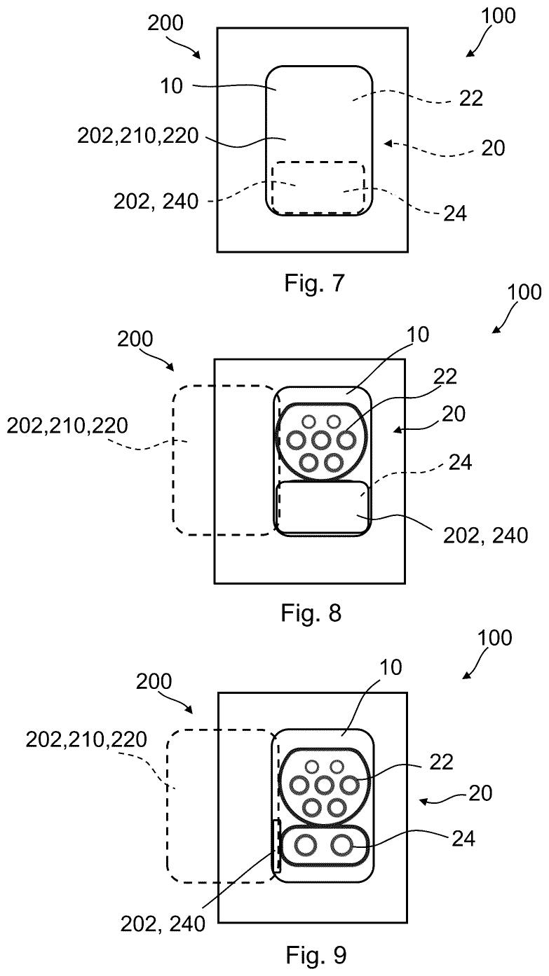

FIGS. 7 to 9 show a charging connection device 100 for an electrically powered vehicle according to a third exemplary embodiment with a combined DC-AC charging connection 20 and a cover arrangement 200 in a covering position (FIG. 7), a first releasing position (FIG. 8) and in a second releasing position (FIG. 9).

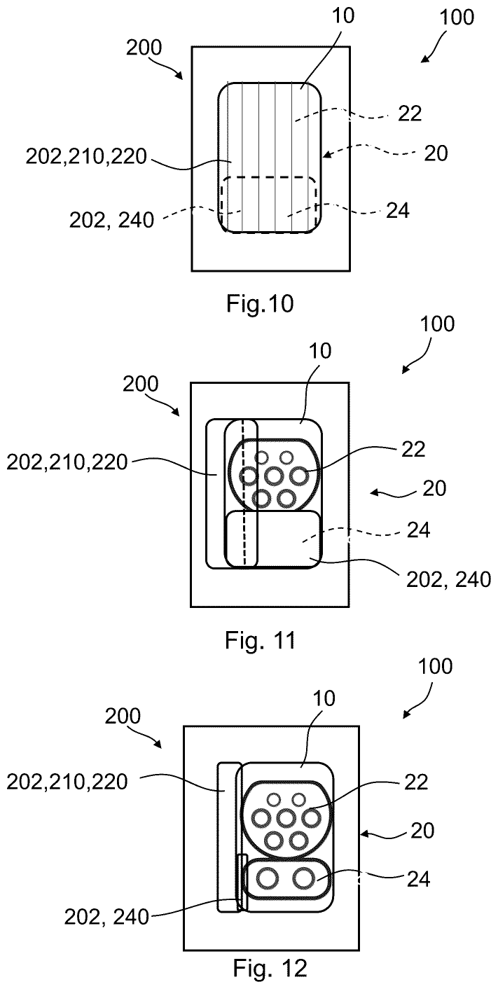

FIGS. 10 to 12 show a charging connection device 100 for an electrically powered vehicle according to a fourth exemplary embodiment with a combined DC-AC charging connection 20 and a cover arrangement 200 in a covering position (FIG. 10), a first releasing position (FIG. 11) and in a second releasing position (FIG. 12).

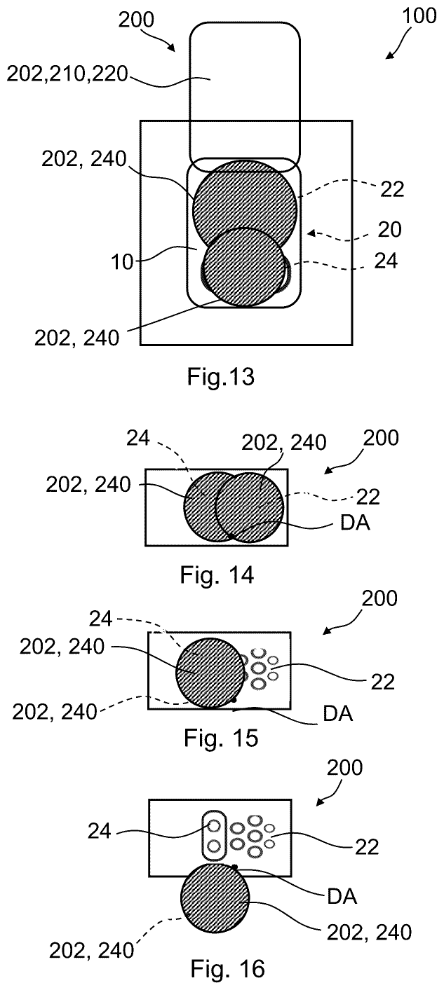

FIG. 13 shows a charging connection device 100 for an electrically powered vehicle according to a fifth exemplary embodiment with a combined DC-AC charging connection 20 and a cover arrangement 200 in an intermediate position.

FIGS. 14 to 16 show the cover arrangement 200 according to FIG. 13 in an intermediate position (FIG. 14), a first releasing position (FIG. 15) and in a second releasing position (FIG. 16).

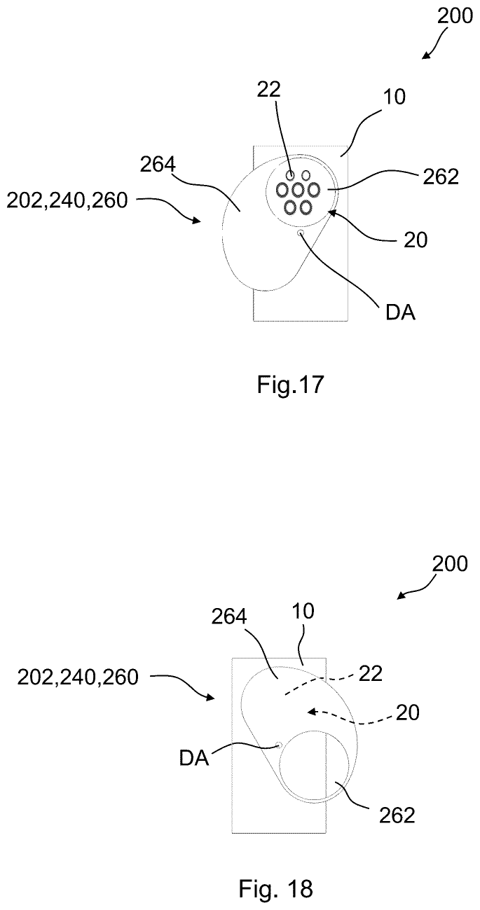

FIGS. 17 and 18 show a cover element 202 of a cover arrangement 200 in the form of a perforated disc 260 in a releasing position (FIG. 17) and in a covering position (FIG. 18);

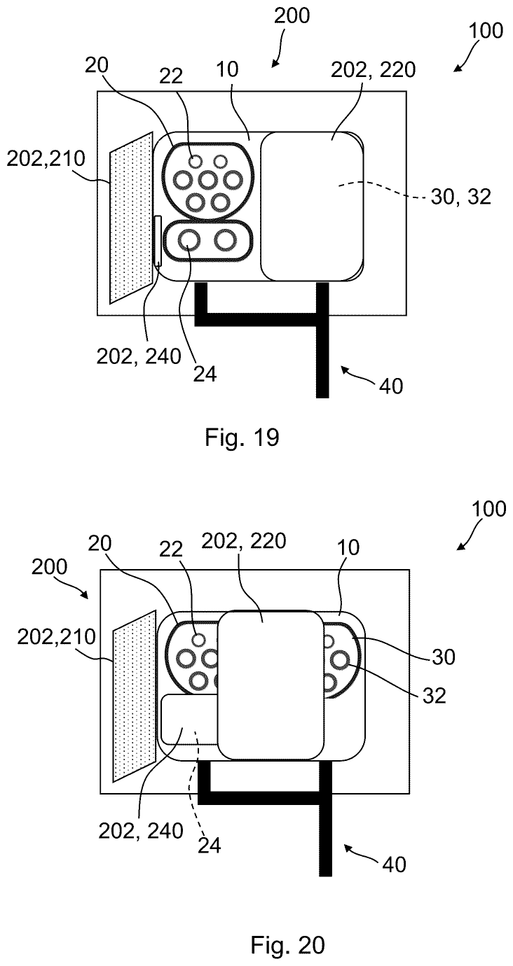

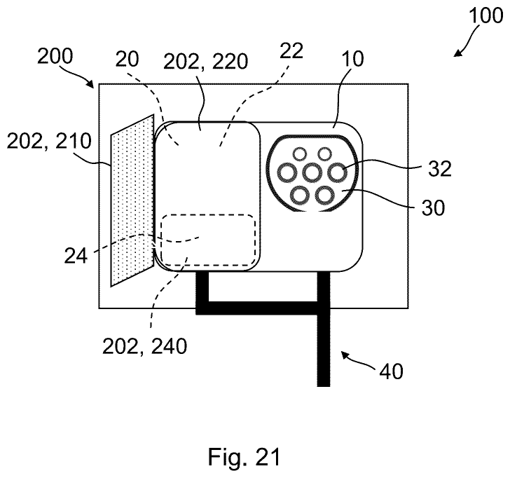

FIGS. 19 to 21 show a charging connection device 100 for an electrically powered vehicle according to a sixth exemplary embodiment with a combined DC-AC charging connection 20, a further charging connection 30 and a cover arrangement 200 in a second releasing position (FIG. 19), an intermediate position (FIG. 20) and in a third releasing position (FIG. 21).

In the following, the common features of the illustrated exemplary embodiments of the charging connection devices 100 will be discussed first and the differences between the illustrated charging connection devices 100 will be discussed in the further course.

As can be seen from FIGS. 1 to 21, the illustrated exemplary embodiments of the charging connection devices 100 for an electrically powered vehicle each comprise at least one charging connection 20, 30. The exemplary embodiments of the charging connection device 100 illustrated in FIGS. 1 to 18 each comprise a charging connection designed as a combined DC-AC charging connection 20, while the exemplary embodiment of the charging connection device 100 illustrated in FIGS. 19 to 21 comprises a further charging connection 30 in addition to the combined DC-AC charging connection 20.

As can be further seen from FIGS. 1 to 21, the charging connections 20, 30 are each designed as a charging socket, but other suitable charging connections 20, 30 are also conceivable. As can also be seen from the figures, the combined DC-AC charging connection 20 has two types of contact elements 22, 24. The AC contact elements 22 are arranged above the DC contact elements 24. The contact elements 22, 24, 32 of the charging connections 20, 30 each form a mating face.

As can also be seen from FIGS. 1 to 21, the cover arrangement 200 has a covering position (FIGS. 1, 4, 7, 10, 13, 14, 18) and at least two releasing positions (FIGS. 2, 3, 8, 9, 11, 12, 15, 16, 17, 19, 21), wherein the releasing positions of the cover arrangement 200 are each assigned to a charging mode.

As can also be seen from FIGS. 1 to 21, the cover arrangement 200 comprises at least one movably mounted cover element 202, which can be moved between a covering position and at least one releasing position.

In a first releasing position of the cover arrangement 200 (FIGS. 2, 5, 8, 11, 15, 17), the AC contact elements 22 of the combined DC-AC charging connection 20 are released and the DC contact elements 24 of the combined DC-AC charging connection 20 are covered by at least one of the cover elements 202. Furthermore, an existing additional charging connection 30 is covered by at least one cover element 202 in this position. The first released position of the cover arrangement 200 is assigned to an AC charging mode.

In a second releasing position of the cover arrangement 200 (FIGS. 3, 6, 9, 12, 16, 19), the AC contact elements 22 and the DC contact elements 24 of the combined DC-AC charging connection 20 are released. Furthermore, an existing additional charging connection 30 is covered in this position by at least one cover element 202 (FIG. 19). The second released position of the cover arrangement 200 is associated with a DC charging mode.

In the covering position of the cover arrangement 200 (FIGS. 1, 4, 7, 10, 13), the charging connections 20, 30 are covered by at least one cover element 202.

The sixth exemplary embodiment of the charging connection device 100 shown in FIGS. 19 to 21 comprises the further charging connection 30, which is electrically coupled to the combined DC-AC charging connection 20 via a common electrical path 40. Both charging connections 20 and 30 are energized. The two charging connections 20, 30 arranged next to each other in the common electrical path 40 are connected in parallel. No separating elements are required to separate the charging connections 20, 30. At least one cover element 202 of the cover arrangement 200 covers the further charging connection when the cover arrangement 200 has the first releasing position or the second releasing position or the covering position.

As can also be seen from FIG. 21, the cover arrangement 200 has a third releasing position in which the further charging connection 30 is released and the DC-AC charging connection 20 is covered by at least one cover element 202. The third released position of the cover arrangement 200 is assigned to a further charging mode.

During a charging process, only the contact elements 22, 24, 32 assigned to a current charging mode are accessible for contacting through the cover arrangement 200, while the other contact elements are covered by at least one cover element 202, in particular covered in a touch-proof manner. As a result, it is only possible to couple a plug with the corresponding contact elements 22, 24, 32 if the other charging connection 20, 30 or the other contact elements 22, 24, 32, which are not assigned to the charging mode assigned to the plug, are covered so that they cannot be touched. This ensures that the unused live charging connection 20, 30 or unused contact elements 22, 24, 32 are covered to prevent contact during the charging process. In addition, the unused, energized charging connection 20, 30 or the unused contact elements 22, 24, 32 are protected from environmental influences such as dirt or water.

As can be further seen from FIGS. 1 to 3, the first exemplary embodiment of the charging connection device 100 comprises a cover arrangement 200 with a cover element 202, which is formed as a charging connection cover 220 and which is assigned to the combined DC-AC charging connection 20. In a first releasing position (FIG. 2), the charging connection cover 220 releases the AC contact elements 22 and covers the DC contact elements 24. In a second releasing position (FIG. 3), the charging connection cover 220 releases the AC contact elements 22 and the DC contact elements 24. In a covering position (FIG. 1), the charging connection cover 220 covers the AC contact elements 22 and the DC contact elements 24. The charging connection cover 220 may have the covering position when the cover arrangement 200 has the covering position or the third uncovering position. In the exemplary embodiment of the charging connection device 100 shown in FIGS. 1 to 3, the charging connection cover 220 is moved from top to bottom in order to be transferred from the covering position to the releasing positions. Here, the charging connection cover 220 moves above the plug faces or parallel to the plug faces. When moving from the covering position to the second releasing position, the charging connection cover 220 does not stop in the first releasing position, but is transferred directly to the second releasing position without stopping. In the illustrated exemplary embodiment, the charging connection cover 220 has at least one sealing element 222 on a side facing the combined DC-AC charging connection 20. The sealing element 222 is shown as a dashed line. In the illustrated exemplary embodiment, the sealing element 222 seals the DC contact elements 24 in the covering position of the charging connection cover 220. Here, the sealing element 222 encloses an area opposite the DC contact elements 24. In an alternative exemplary embodiment (not shown), a further sealing element 222 can cover the AC contact elements 22. Furthermore, an arrangement of the sealing elements 222 is conceivable which enables sealing of the DC contact elements 24 in the first releasing position of the charging connection cover 220. The sealing element 222 can be formed from plastic or another suitable material.

As can also be seen from FIGS. 1 to 3, the charging connection cover 220 also covers the charging recess 10, in which the combined DC-AC charging connection 20 is arranged. As a result, the charging connection cover 220 also fulfils the function of a charging recess cover 210 in the exemplary embodiment shown.

As can be further seen from FIGS. 4 to 21, the further exemplary embodiments of the charging connection device 100 comprise an exemplary embodiment of the cover arrangement 200, which comprises a cover element 202 formed as a charging connection cover 220 and a cover element 202 formed as a connection cover element 240. In a releasing position, the charging connection cover 220 at least partially releases the combined DC-AC charging connection 20 and in a covering position covers the combined DC-AC charging connection. The connection cover element 240 releases the DC contact elements 24 in a releasing position and covers the DC contact elements 24 in a covering position.

As can be further seen from FIGS. 4, 7, 10, 19, the charging connection cover 220 in the covering position covers the AC contact elements 22 and the connection cover element 240 as well as the DC contact elements 24. The connection cover element 240 is arranged between the DC contact elements 24 and the charging connection cover 220. In the covering position, the charging connection cover 220 also acts as a charging recess cover 210, which covers the charging recess 10 in which the charging connection 20 is arranged.

In order to move the cover arrangement 200 into the first releasing position, the charging connection cover 220 is moved into the releasing position, in which the charging connection cover 220 releases the AC contact elements 22 and the connection cover element 240. The DC contact elements 24 are covered by the connection cover element 240. In order to move the cover arrangement 200 into the second releasing position, the charging connection cover 220 is moved into the releasing position and the connection cover element 240 is moved from the covering position into the releasing position.

The exemplary embodiments of the charging connection device 100 shown in FIGS. 4 to 21 differ in particular in the design of the cover elements 202. Combinations of the exemplary embodiments not shown are also possible.

In FIGS. 4 to 6, the charging connection cover 220 is designed as a translationally movable flap, which is moved upwards into the releasing position in front of the outer shell. The connecting cover element 240 is also designed as a translationally movable flap, which is moved downwards into the releasing position in front of the outer shell. It would also be conceivable to move the charging connection cover 220 and/or the connecting cover element 240 laterally. In addition, the charging connection cover 220 can be moved downwards into the releasing position. In the case of the charging connection cover 220, it should be noted that it does not cover the connecting cover element 240 in the releasing position. It should be noted that the connection cover element 240 does not cover the AC contact elements 22 in the releasing position.

In FIGS. 7 to 9, the charging connection cover 220 is designed as a translationally movable flap, which is displaced to the side behind the outer shell of the body shell into the releasing position. Displacement in other spatial directions behind the outer shell is also conceivable. The connecting cover element 240 is designed as a pivotably mounted flap that folds outwards to the side. The swiveling axis is arranged at the edge of the charging connection and runs in a vertical direction in the exemplary embodiment shown. The connecting cover element 240 can also fold away at the bottom, in which case the swiveling axis can run in the longitudinal direction. The connecting cover element 240 can also be folded in other directions. It should be noted that the connection cover element 240 does not cover the AC contact elements 22 in the released position.

In FIGS. 10 to 12, the charging connection cover 220 is designed as a roller blind, which can be folded and pushed to the side in order to be moved into the releasing position. In an alternative embodiment, the roller blind can be rollable or bendable. The roller blind can be made of plastic or sheet metal, which can be rolled up and folded or moved inwards. The roller blind can also fold inwards in an S-shape. The movement can be performed upwards, downwards, to the left or to the right. A version of the roller blind with slats is also possible.

The exemplary embodiment of the charging connection device 100 shown in FIGS. 13 to 16 shows a cover arrangement 200 with a charging connection cover 220 and two connection cover elements 240, wherein one connection cover element 240 covers AC contact elements 22 in the covering position and releases them in the releasing position. The other connection cover element 240 covers DC contact elements 24 in a covering position and releases the DC contact elements in a releasing position. As can be further seen from FIGS. 14 to 16, the connection cover elements 240 are designed as rotationally movable round discs, which are mounted to rotate about the same axis of rotation. In this case, the discs rotate in a plane parallel to the contact elements 22, 24. In an alternative exemplary embodiment not shown, the discs can also each be rotated about their own axis of rotation. Other shapes of the discs are also conceivable. In the covering position of the cover arrangement 200 or in the third releasing position of the cover arrangement 200, the charging connection cover 220 has the covering position and covers both connection cover elements 240. In addition, the charging connection cover 220 acts as a charging recess cover 210, which covers or releases the charging recess 10 in which the charging connection 20 is arranged.

In the covering position of the cover arrangement 200 or in the third releasing position of the cover arrangement 200, the connecting cover elements 240 also have the covering position.

FIGS. 13 and 14 show an intermediate position of the cover arrangement 200, in which the charging connection cover 220 has the releasing position and the connection cover elements 240 have the covering position.

In order to transfer the cover arrangement 200 from the covering position to the first releasing position, the charging connection cover 220 and the connection cover element 240, which covers the AC contact elements 22, are transferred to the releasing position. In the illustrated exemplary embodiment, in the first releasing position, the connection cover elements 240 are arranged congruently in the position covering the DC contact elements 24 (FIG. 15).

In order to transfer the cover arrangement 200 from the covering position to the second releasing position, the charging connection cover 220 and both connection cover elements 240 are transferred to the releasing position. In the illustrated exemplary embodiment, in the second releasing position the connection cover elements 240 are arranged congruently in the position releasing the DC contact elements 24 and the AC contact elements 22 (FIG. 16).

In an alternative exemplary embodiment (not shown) of the cover arrangement 200, the connecting cover elements 240 can also be designed as swiveling or translationally movable flaps.

As can also be seen from FIGS. 17 and 18, a connection cover element 240 can also be designed as a perforated disc 260 with at least one opening 262 or recess in the form of the corresponding mating face. The perforated disc 260 also comprises a main body 264, which covers areas of the charging connection 20 not released by the opening 262, in particular contact elements 22. The cover arrangement 200 can have several perforated discs 260, with each perforated disc 260 being assigned to certain contact elements 22, 24, 32 and covering or uncovering them depending on the angular position. In addition, a perforated disc 260 with a plurality of openings 262 is conceivable, wherein in a first angular position an opening releases the AC contact elements 22 and in a second angular position the openings or the second opening release the AC contact elements 22 and the DC contact elements 24 and in a third angular position the main body 264 covers the AC contact elements 22 and the DC contact elements 24.

As can also be seen from FIGS. 19 to 21, in the illustrated exemplary embodiment of the charging connection device 100, the two charging connections 20, 30 are arranged in a common charging recess 10. The charging recess 10 has a swiveling charging recess cover 210, which covers the charging connections 20, 30 and corresponding cover elements 202 in a covering position and releases them in a releasing position.

In FIGS. 19 to 21, the charging connection cover 220 is designed as a translationally movable flap, which is displaced to the side. In the first and second releasing positions of the cover arrangement 200 (FIG. 19), the charging connection cover 220 has the first releasing position, in which it is arranged over the further charging connection 30 and covers its contact elements 32. This enables the combined DC-AC charging connection 20.

The connecting cover element 240 is designed as a hinged flap that folds outwards. In the first releasing position of the cover arrangement 200, the connecting cover element 240 has the covering position.

In the second releasing position of the cover arrangement 200 (FIG. 19), the connection cover element 240 has the releasing position, so that the AC contact elements 22 and the DC contact elements 24 are released.

In the third releasing position of the cover arrangement 200, the charging connection cover 220 is arranged over the combined DC-AC charging connection 20 and covers it. As a result, the further charging connection 30 is released.

A drive of the cover arrangement 200, which is not shown, can move the cover elements 202 between the positions. In addition, at least one sensor arrangement, not shown, coupled to the cover arrangement 200 or to the drive can determine a current charging mode. As a result, the at least one drive can, depending on the charging mode recognized by the sensor arrangement, move the cover elements 202 into the position in which only the charging connection 20, 30 assigned to the charging mode or the contact elements 22, 24, 32 of the charging connection 20, 30 assigned to the charging mode are released. This enables fully automatic or semi-automatic release of the required contact elements.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

10 charging recess
20 charging connection
22 AC contact elements
24 DC contact elements
30 charging connection
40 electrical path
100 charging connection device
200 cover arrangement
202 cover element
210 charging recess cover
220 charging connection cover
222 sealing element
240 connection cover element
260 perforated disc
262 opening
264 main body

1-10. (canceled)

11. A charging connection device for an electrically propelled vehicle, the charging connection device comprising:
at least one charging connection, which is a combined DC-AC charging connection with AC contact elements and DC contact elements;
a cover arrangement comprising at least one movably mounted cover element movable into a covering position and at least two releasing positions, wherein the two releasing positions of the cover arrangement are each assigned to a charging mode; and
at least one sensor arrangement coupled to the cover arrangement and configured to detect the charging mode according to alternating current or direct current,
wherein, in a first of the at least two releasing positions the AC contact elements of the DC-AC charging connection are released and the DC contact elements of the DC-AC charging connection are covered by the at least one movably mounted cover element,
wherein in a second of the at least two releasing positions the AC contact elements and the DC contact elements of the DC-AC charging connection are released, and
wherein, in the covering position the charging connections are covered by the at least one movably mounted cover element.

12. The charging connection device of claim 11, further comprising:
a further charging connection electrically coupled, via a common electrical path, to the combined DC-AC charging connection,
wherein the at least one movably mounted cover element covers the further charging connection when the cover arrangement has the first releasing position, the second releasing position, or the covering position.

13. The charging connection device of claim 12, wherein the at least two releasing positions include a third releasing position of the cover arrangement in which the further charging connection is released and the DC-AC charging connection is covered by the at least one cover element.

14. The charging connection device of claim 11, wherein the at least one movably mounted cover element is a charging connection cover assigned to the combined DC-AC charging connection, wherein
the charging connection cover in the first releasing position releases the AC contact elements and covers the DC contact elements,
the charging connection cover in the releasing second releasing position releases the AC contact elements and the DC contact elements, and
the charging connection cover in the covering position covers the AC contact elements and the DC contact elements.

15. The charging connection device of claim 14, wherein the charging connection cover comprises at least one sealing element on a side facing the combined DC-AC charging connection.

16. The charging connection device of claim 13, wherein the at least one movably mounted cover element comprises a charging connection cover and a connection cover element, wherein
the charging connection cover at least partially releases the combined DC-AC charging connection in a releasing position and covers the combined DC-AC charging connection in a covering position, and
the connection cover element releases the DC contact elements in a releasing position and covers the DC contact elements in a covering position.

17. The charging connection device of claim 16, wherein the charging connection cover covers the further charging connection in the third releasing position.

18. The charging connection device of claim 16, further comprising:
an additional connection cover element configured to release the AC contact elements in a releasing position and cover the AC contact elements in a covering position.

19. The charging connection device of claim 11, wherein the at least one movably mounted cover element is a rotationally movable or translationally movably mounted flap, is a foldable, rollable, or bendable roller blind, or is a rotatable element in the form of a perforated disc.
